(19) United States
(12) Patent Application Publication
(10) Pub. No.: US 2009/0083371 A1
(43) Pub. Date: Mar. 26, 2009

(54) Method and System for Realizing Electronic Data Output

(76) Inventor: Ying Keung Chan, Hong Kong (CN)

Correspondence Address: BYIP, LTD., P.O. BOX 1484, GENERAL POST OFFICE, HONG KONG, CN

(21) Appl. No.: 12/032,651

(22) Filed: Feb. 16, 2008

(30) Foreign Application Priority Data
Apr. 13, 2007 (CN) 200710090131.3

(51) Int. Cl. G06F 15/16

(52) U.S. Cl. 709/203

(57) ABSTRACT

The present application discloses a method and system for realizing electronic data output. The method includes the following steps: collecting electronic data; transforming the electronic data to desired format to be stored; reading the transformed electronic data through network; and outputting the transformed electronic data to medium.

### CROSS REFERENCE OF RELATED APPLICATION

The present patent application claims priority of Chinese patent application no. 200710090131.3 filed Apr. 13, 2007.

### FIELD OF APPLICATION

The present application relates to a method and system for realizing electronic data output.

### DESCRIPTION OF RELATED ARTS

Network trade becomes a new trend of enterprise development. When the enterprise receives a network table sheet of client through the website, she should print out the network table sheet through the printer to obtain delivery note and delivery order etc. on some specific application.

In the process of realizing the present application, the inventor finds at least existing following problems in prior arts:

Prior art one is using IP network to print, the data on the website is initiatively connected to the printer through IP network.

Adopting the manner of prior art one, the enterprise needs fixed IP position, in order to initiatively connect with the website, and needs continuous connecting line, moreover same data could not simultaneously support multiple printers to print, and the website links initiatively, when the Client disconnects, the website needs to continuously try to connect the Client, which causes waste of resource.

Prior art two is using manual manner to print, the enterprise needs to log on the website to monitor and control the network table sheet of user submission, and print the network table sheet by manpower manipulation.

Adopting the manner of prior art two, the enterprise needs to set a specialized person to monitor and control, use the printer only when it needs to print, and same table sheet could not simultaneously support multiple printers to print.

### SUMMARY

The present application provides a method and system for realizing electronic data output, which could output the submitted electronic data according to desired format.

In one aspect, it provides a method for realizing electronic data output, comprising following steps:

collecting electronic data;

transforming the electronic data to desired format to be stored;

reading the transformed electronic data through network; and

outputting the transformed electronic data to medium.

The medium includes printed matter or display terminal.

The step of outputting the transformed electronic data to medium includes following steps:

printing the transformed electronic data on the printed matter; or

displaying the transformed electronic data on the display terminal.

The step of outputting the transformed electronic data to medium includes following steps:

selecting output destination of the transformed electronic data in terms of requirement; and

outputting the transformed electronic data on the medium of destination in terms of select result.

The electronic data is table sheet information of user submission.

In another aspect, the present application provides a bridge-linking server, which includes:

a data processing unit for transforming the collected electronic data to desired format;

a storage unit for storing the transformed electronic data; and

a transmit unit for sending the transformed electronic data in terms of the received read signal.

The data processing unit includes:

a data collecting device for collecting electronic data; and

a transform device for transforming the electronic data to desired format to send it to the storage unit.

In another aspect, the present application provides a bridge-linking Client, which includes:

a read unit for reading the transformed electronic data through network; and

a transmit unit for output the electronic data on the medium.

The bridge-linking Client further includes a select unit for judging the output destination of the electronic data in terms of requirement; the transmit unit outputs the electronic data on the medium of the destination.

In another aspect, the present application provides a system for realizing electronic data output, which includes:

a bridge-linking server for transforming the collected electronic data to desired format to be stored; and

a bridge-linking Client for reading the transformed electronic data through network, and output the transformed electronic data on the medium.

The bridge-linking server includes:

a data processing unit for transforming the collected electronic data to desired format;

a storage unit for storing the transformed electronic data; and

a transmit unit for sending the transformed electronic data to the bridge-linking Client in terms of the read signal of the bridge-linking Client.

The data processing unit of the bridge-linking server includes:

a data collecting device for collecting electronic data; and

a transform device for transforming the electronic data to desired format to send it to the storage unit.

The bridge-linking client includes:

a read unit for reading the transformed electronic data from the bridge-linking server; and

a transmit unit for output the transformed electronic data on the medium.

The bridge-linking Client further includes a select unit for judging the output destination of the electronic data in terms of requirement; the transmit unit of the bridge-linking Client outputs the electronic data on the medium of the destination.

The above technical schemes have following advantage or beneficial effect:

Because the present application initiatively reads the transformed electronic date, it overcomes the technical problem of prior art which needs to set a surveillant to monitor and control whether there is some electronic data to be printed, it saves person cost; it also overcomes the technical problem of prior art that the website continually tries to connect the Client to cause waste of resource, it further saves the cost; store the collected electronic data then to read, could cause multiple bridge-linking Clients to read the same electronic data simultaneously, it responds quickly and needs no fixed IP, even if the network is unstable sheet, it could also guarantee the correctness of data output.

### BRIEF DESCRIPTION OF THE DRAWINGS

FIG. 1 is a flow chart of realizing electronic data output in one embodiment.

FIG. 2 is a network structure chart of realizing electronic data output in one embodiment.

FIG. 3 is a structure chart of realizing electronic data output in one embodiment.

FIG. 4 is a network structure chart of realizing electronic data output in another embodiment.

FIG. 5 is a structure chart of realizing electronic data output in another embodiment.

FIG. 6 is a structural schematic diagram of the system for realizing electronic data output in one embodiment.

FIG. 7 is a network structure chart of realizing electronic data output in another embodiment.

### DETAILED DESCRIPTION

One embodiment of the present application, the system for realizing electronic data output comprises bridge-linking server and bridge-linking Client, the bridge-linking server is responsible for processing the network data to send it to temporary stored database, the bridge-linking Client makes use of software/hardware program to initiatively reads data and print/output it on other mediums to become genuine table sheet through network.

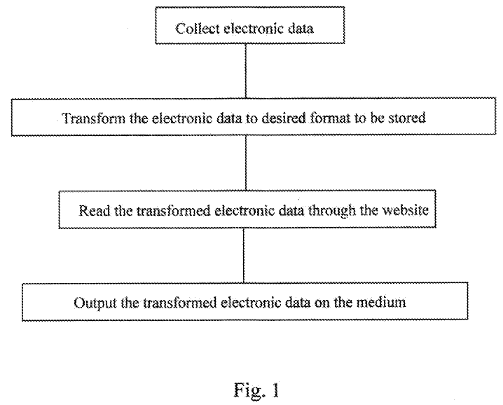

FIG. 1 is a flow chart of realizing electronic data output in one embodiment of the present application, refer to FIG. 1, the whole course and work method is as follows:

When the website receives a network table sheet of user submission through the present system, it will clean up the table sheet data or process the data format through the system, then transform to the required table sheet format by the client, and automatically gather together into the temporary stored database.

The bridge-linking Client initiatively reads the temporary stored data through network and controls the output device to output on the medium, and converts to the desired document. The medium includes printed matter or display terminal. The bridge-linking Client initiatively reads the temporary stored data through network, control the printer to print on the printed matter to form order form, delivery note or delivery order etc., the printed matter includes paper sheets, plastics or leather etc.: or the bridge-linking Client controls PDA etc. devices to display the temporary stored data. The bridge-linking Client could adopt PC, MAC or other common controllers to implement.

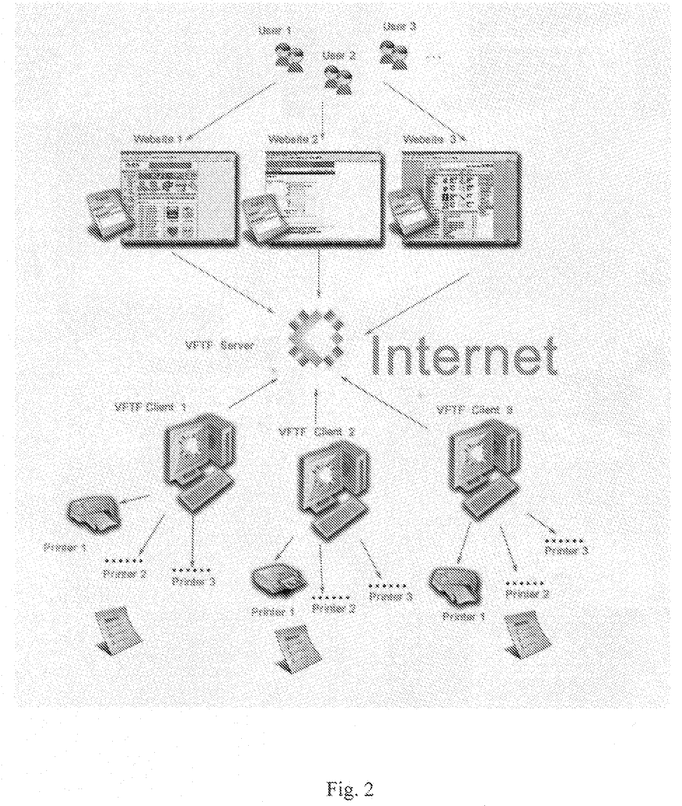

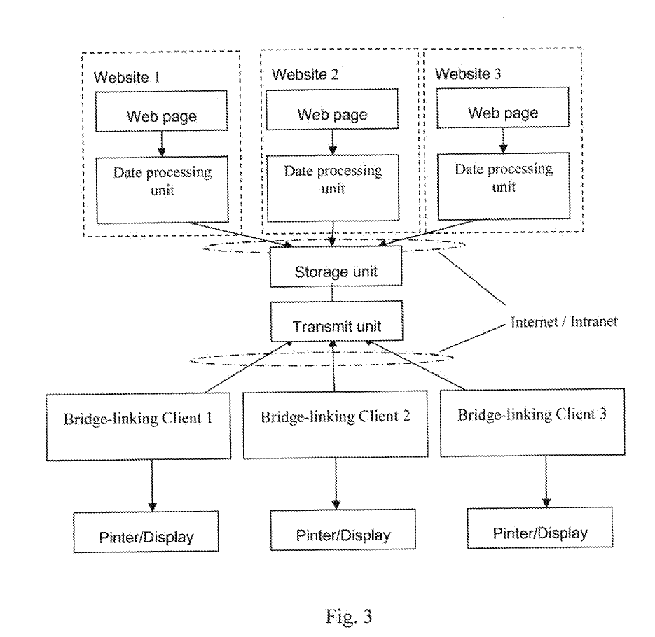

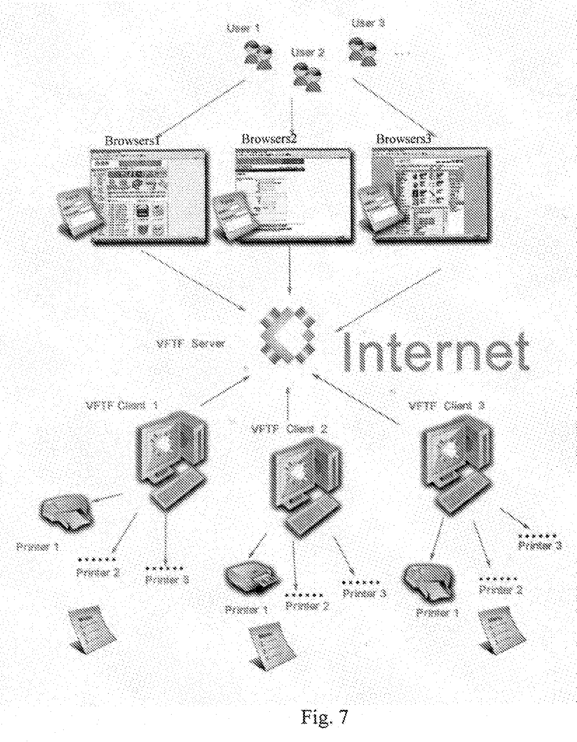

FIG. 2 a network structure chart of realizing electronic data output, FIG. 3 is a corresponding structure chart, refer to FIGS. 2, 3, User1, User2 and User3 input the data to Website1, Website2 and Website3, afterwards the website could transfer the table sheet data to the bridge-linking server (VFTF Server), the bridge-linking server processes the data. The bridge-linking Client (VFTF Client) connects the bridge-linking server to read the table sheet data, and print or display. Wherein, the data processing unit of the bridge-linking server could be added to each website in embedded form, in this way the bridge-linking server separately sets a data processing unit corresponding to each website, the bridge-linking Client (VFTF Client 1, VFTF Client 2, VFTF Client 3) separately accesses the transmit unit to obtain the desired electronic data. In this embodiment, the bridge-linking server collects the data from the website, refer to FIG. 7, the bridge-linking server further could collect data from the existing other data management system, i.e. collect data from meal management software, when service staff (User1, User2, User3) receives order form, he will input correlative electronic data of the order form through the input interface of the meal management software, the bridge-linking server (VFTF Server) collects data from the meal management software, and converts the format to be stored, moreover the bridge-linking Client reads the converted electronic data from the bridge-linking server to print, thus it is no need to arrange a meal personnel to continually see the order form on the computer, and the meal personnel could directly receive the order form document, based on the printed order form, he tallies the cargo and delivers goods. Using the system, it could realize the output of order form etc. electronic data striding zones.

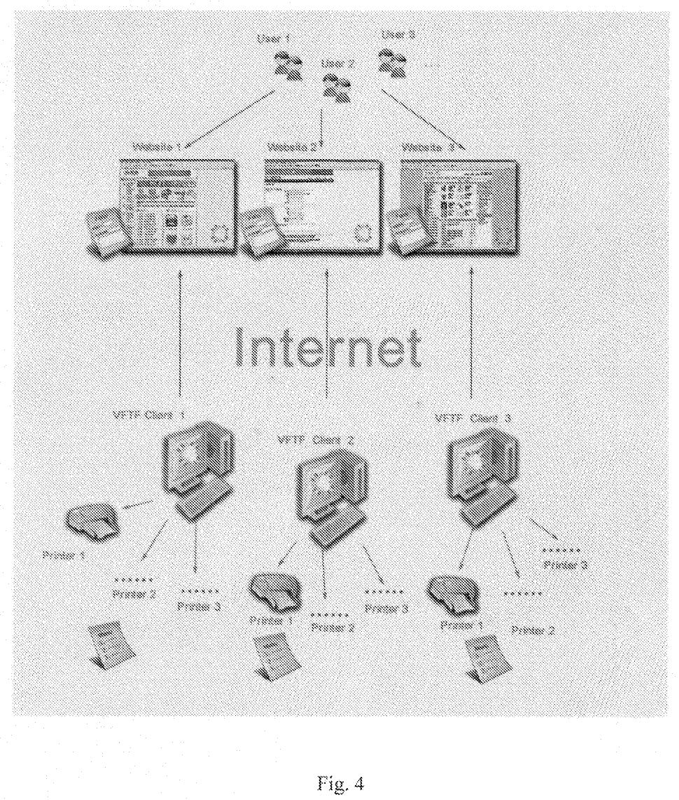

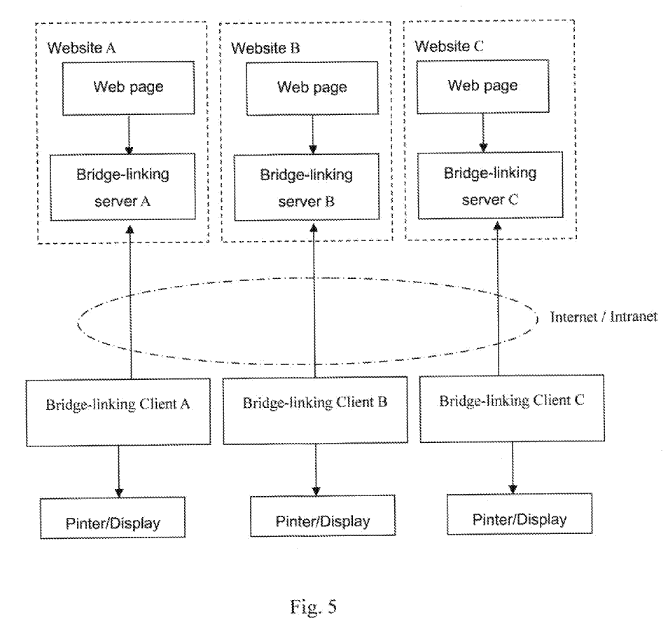

FIG. 4 is another network structure chart of realizing electronic data output, FIG. 5 is a corresponding structure chart, refer to FIGS. 4 and 5, the bridge-linking server (VFTF Server 1, VFTF Server 2, VFTF Server 3) is separately added to the website in embedded form, and the bridge-linking Client (VFTF Client 1, VFTF Client 2, VFTF Client 3) separately connects the corresponding website to read data, and print or display.

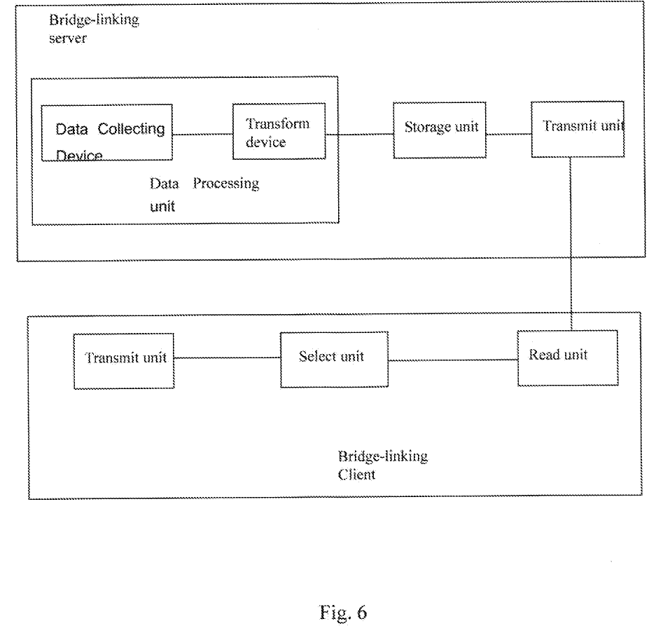

FIG. 6 is another structural schematic diagram of the system for realizing electronic data output, referring to FIG. 6, which includes:

a bridge-linking server for transforming the collected electronic data to desired format to be stored; and

a bridge-linking Client for reading the transformed electronic data through network, and output the transformed electronic data on the medium.

The bridge-linking server includes:

a data processing unit for transforming the collected electronic data to desired format;

a storage unit for storing the transformed electronic data; and

a transmit unit for sending the transformed electronic data to the bridge-linking Client in terms of the read signal of the bridge-linking Client.

The data processing unit of the bridge-linking server includes: a data collecting device for collecting electronic data; and a transform device for transforming the electronic data to desired format to send it to the storage unit.

The bridge-linking Client includes: a read unit for reading the transformed electronic data from the bridge-linking server; and a transmit unit for output the transformed electronic data on the medium.

The bridge-linking Client further includes a select unit for judging the output destination of the electronic data in terms of requirement; the transmit unit of the bridge-linking Client outputs the electronic data on the medium of the destination.

Embodiment One, develop a to go website of dietetic trade using the system of realizing electronic data output.

When a user speaks for meal from a businessman of the website, the system will directly print/display the website table sheet of the user to the businessman, and deliver the website table sheet to the kitchen, gathering place or delivery site etc.

The kitchen, gathering place or delivery site etc. of the businessman could directly obtain the table sheet output by the system to proceed corresponding after working procedure, such as compounding food, charging on and delivering goods etc., without installing computer and setting special surveillant.

Embodiment Two, using the system and existing website to process adequate and systematic service, make the electronic data of the website output through the system, which reduce the operating and running cost of the website.

For example, network electronic shop or electronic commerce website, when user makes an order for goods from the website, the businessman of the website needs no special person to log on the website to obtain relative data, and that the bridge-linking server collects the data from the network electronic shop or electronic commerce website, and transforms the data format to be stored, the bridge-linking Client outputs the transformed electronic data to the businessman of the website, the businessman of the website could receive the printed order form promptly, thus increase efficiency of ordering of the website and reduce operating cost of the website.

The person skilled in the art could comprehend the whole or part steps of the above method in the embodiment could be accomplished by relative hardware dictating through a program, the program could be stored in a computer readable storage medium, when the program is performing, comprising following steps: collect electronic data; transform the electronic data to desired form to be stored, the storage medium, i.e. ROM/RAM, diskette, CD etc.

The above introduces in details a method and system for realizing electronic data output of the present application. The embodiments described above are used to exemplify the present application only and not intended to be limiting. Within the scope of the technical features disclosed in the present application, anyone skilled in the art will carry out other part-changed or modified equivalent embodiments without departure from the content of the technical features of the present application. Therefore these embodiments still belong to the scope of the technical features of the present application.

I claim:

1. A method for realizing electronic data output, comprising:
collecting an electronic data;
transforming the electronic data to a desired format to be stored;
reading the transformed electronic data through a network; and
outputting the transformed electronic data to a medium.

2. The method according to claim 1, wherein the medium comprises a printed matter or a display terminal.

3. The method according to claim 2, wherein the step of outputting the transformed electronic data to a medium comprises:
printing the transformed electronic data on the printed matter or displaying the transformed electronic data on the display terminal.

4. The method according to claim 1, wherein the step of outputting the transformed electronic data to a medium comprises:
selecting an output destination of the transformed electronic data in terms of requirement; and
outputting the transformed electronic data on the medium of destination in terms of select result.

5. The method according to claims 1, wherein the electronic data is table sheet information of user submission.

6. A bridge-linking server, comprising:
a data processing unit for transforming collected electronic data to a desired format;
a storage unit for storing the transformed electronic data; and
a transmit unit for sending the transformed electronic data in terms of a received read signal.

7. The bridge-linking server according to claim 6, wherein the data processing unit comprises:
a data collecting device for collecting electronic data;
a transform device for transforming the electronic data to a desired format to send it to the storage unit.

8. A bridge-linking client comprising:
a read unit for reading the transformed electronic data through a network; and
a transmit unit for output the electronic data on a medium.

9. The bridge-linking client according to claim 8, further comprising a select unit for judging the output destination of the electronic data in terms of requirement; the transmit unit outputs the electronic data on the medium of the destination.

10. A system for realizing electronic data output, comprising:
a bridge-linking server for transforming a collected electronic data to a desired format to be stored; and
a bridge-linking client for reading the transformed electronic data through a network and outputting the transformed electronic data on a medium.

11. The system according to claim 10, wherein the bridge-linking server comprises:
a data processing unit for transforming the collected electronic data to the desired format;
a storage unit for storing the transformed electronic data;
a transmit unit for sending the transformed electronic data to the bridge-linking client in terms of the read signal of the bridge-linking Client.

12. The system according to claim 11, wherein the data processing unit of the bridge-linking server comprises:
a data collecting device for collecting an electronic data; and
a transform device for transforming the electronic data to the desired format and sending it to the storage unit.

13. The system according to claims 10, wherein the bridge-linking client comprises:
a read unit for reading the transformed electronic data from the bridge-linking server; and
a transmit unit for outputting the transformed electronic data on the medium.

14. The system according to claim 13, wherein the bridge-linking client further comprising a select unit for judging the output destination of the electronic data in terms of requirement; the transmit unit of the bridge-linking Client outputs the electronic data on the medium of the destination.
